(19) United States
(12) Patent Application Publication
(10) Pub. No.: US 2022/0095786 A1
(43) Pub. Date: Mar. 31, 2022

(54) MOVING BODY AND CONTROL METHOD

(71) Applicant: SONY GROUP CORPORATION, TOKYO (JP)

(72) Inventors: KOHEI KOJIMA, TOKYO (JP); MIKIO NAKAI, KANAGAWA (JP); KUNIAKI TORII, TOKYO (JP); TAICHI YUKI, TOKYO (JP); KAZUNORI YAMAMOTO, TOKYO (JP); TAKAMORI YAMAGUCHI, TOKYO (JP); CHAO WANG, TOKYO (JP); MASATAKA TOYOURA, TOKYO (JP); YOSHIHITO OHKI, TOKYO (JP)

(21) Appl. No.: 17/310,502

(22) PCT Filed: Jan. 31, 2020
(86) PCT No.: PCT/JP2020/003608

§ 371 Date: Aug. 6, 2021

(30) Foreign Application Priority Data
Feb. 15, 2019 (JP) 2019-025715

(51) Int. Cl. A47B 9/00; G06V 40/20; G06V 20/50; G05B 15/02

(52) U.S. Cl. CPC A47B 9/00; G06V 40/20; A47B 2200/0062; G05B 15/02; G06V 20/50

(57) ABSTRACT

The present technology relates to a moving body and a control method capable of improving affinity of the moving body for a person and a space. A moving body according to one aspect of the present technology includes a top plate that serves as a desk at which a person performs work, a support arm that supports the top plate and that can extend and contract, and a moving unit that holds the support arm and performs movement for causing the work to be performed. Furthermore, the moving body controls a posture state including a state of the support arm and a movement state of the moving unit in accordance with a relationship with an environment state as a state of a surrounding environment and a person state as a state of the person located around, sensed by a sensor. The present technology can be applied to a movable robot.

### TECHNICAL FIELD

The present technology relates to a moving body and a control method, and more particularly to a moving body and a control method capable of improving affinity of the moving body for a person and a space.

### BACKGROUND ART

Conventionally, there is a moving body that autonomously moves by creating an environment map or the like representing a surrounding situation by sensing a surrounding person and environment. Examples of the moving body include an automobile, a robot, and an airplane.

### CITATION LIST

### PATENT DOCUMENT

Patent Document 1: Japanese Patent Application Laid-Open No. 2013-31897
Patent Document 2: Japanese Patent Application Laid-Open No. 2013-22705
Patent Document 3: Japanese Patent Application Laid-Open No. 2012-236244

### SUMMARY OF THE INVENTION

### Problems to be Solved by the Invention

Conventional moving bodies are limited to moving bodies focusing on supporting movement and activities of a person, such as a moving body as a means by which a person moves and a moving body supporting activities of a person such as cleaning.

In particular, as for a moving body having interactivity with a person, there is a demand for a moving body that is easy to use for a user and exists in a form of being blended in a space where the user is.

The present technology has been made in view of such a situation, and an object thereof is to improve affinity of a moving body for a person and a space.

### Solutions to Problems

A moving body according to one aspect of the present technology includes a top plate that serves as a desk at which a person performs work, a support arm that supports the top plate and that can extend and contract, a moving unit that holds the support arm and performs movement for causing the work to be performed, and a control unit that controls a posture state including a state of the support arm and a movement state of the moving unit in accordance with a relationship with an environment state as a state of a surrounding environment and a person state as a state of the person located around, sensed by a sensor.

In one aspect of the present technology, a posture state including a state of the support arm and a movement state of the moving unit are controlled in accordance with a relationship with an environment state as a state of a surrounding environment and a person state as a state of the person located around, sensed by a sensor.

### BRIEF DESCRIPTION OF DRAWINGS

FIG. 1 is a diagram illustrating a use state of a customer service system according to an embodiment of the present technology.

FIG. 2 is a diagram illustrating examples of postures of a customer service robot.

FIG. 3 is an enlarged view of the customer service robot at the time of interaction.

FIG. 4 is an exploded view of a housing.

FIG. 5 is a block diagram illustrating a configuration example of the customer service system.

FIG. 6 is a block diagram illustrating a functional configuration example of a control unit.

FIG. 7 is a diagram schematically illustrating a space where the customer service robot is disposed.

FIG. 8 is a flowchart describing processing of the customer service robot.

FIG. 9 is a diagram illustrating examples of assigned areas.

FIG. 10 is a diagram illustrating an example of division of the assigned area.

FIG. 11 is a diagram illustrating an example of user search.

### MODE FOR CARRYING OUT THE INVENTION

<Overview of Present Technology>

The present technology not only enables a user to intuitively perform work but also enables improvement in affinity for a person and a space so that a moving body itself blends in the space while being close to the person by exerting interactivity with the user.

Furthermore, the present technology is capable of adaptively changing the motion (speed, direction, and the like) of the moving body and the position (height and the like) of a top plate provided on the moving body.

<Application of Customer Service System>

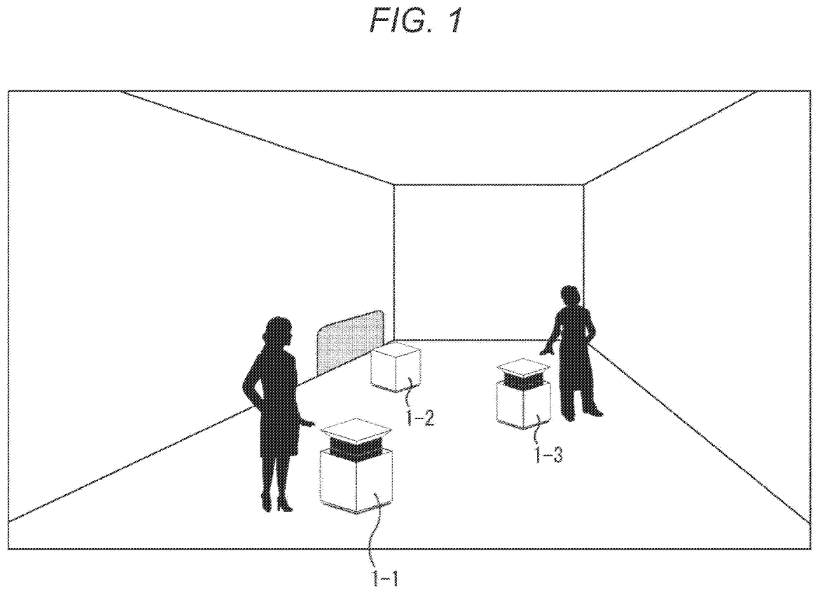

FIG. 1 is a diagram illustrating a use state of a customer service system according to an embodiment of the present technology.

The customer service system in FIG. 1 is used in a room, for example. A person exists in a space where the customer service system is installed.

As illustrated in FIG. 1, a plurality of cuboidal customer service robots is prepared in the room. In the example in FIG. 1, three customer service robots 1-1 to 1-3 are illustrated. In a case where it is not necessary to distinguish the respective customer service robots, they are collectively referred to as a customer service robot 1 as appropriate.

The customer service robot 1 is a moving body that moves on a floor surface. The bottom surface of the customer service robot 1 is provided with a configuration such as a tire used for movement of the customer service robot 1.

The customer service robot 1 has a function of searching for a person in the room on the basis of an image captured by a camera or the like, and approaching the person detected by the search to serve the customer. For example, the customer service robot 1 serves a customer for asking for an answer to a questionnaire. The customer service system using the customer service robot 1 is used, for example, in an exhibition venue, a concert venue, a movie theater, an amusement facility, and the like.

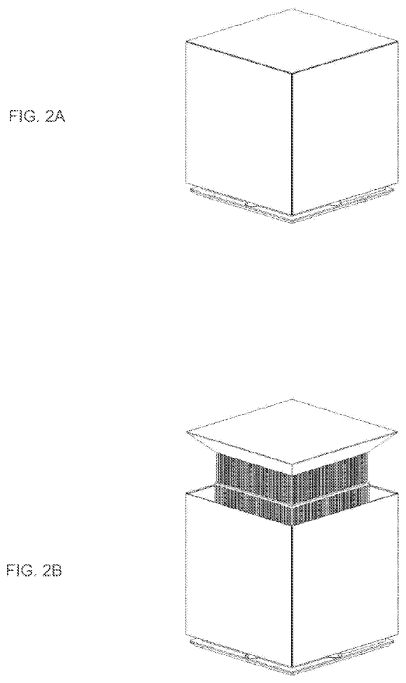

FIG. 2 is a diagram illustrating examples of postures of the customer service robot 1.

The state of the customer service robot 1 illustrated in A of FIG. 2 is a state at the time of movement. While moving to a destination, the customer service robot 1 moves in a substantially cubic state. In a case where the customer service robot 1 stands by at a predetermined place without serving a customer as well, the state of the customer service robot 1 is the substantially cubic state as illustrated in A of FIG. 2.

The state of the customer service robot 1 illustrated in B of FIG. 2 is a state at the time of interaction, that is, at the time of providing a customer service to a target user. In a case of serving a customer, the customer service robot 1 controls its own posture to a state where a top plate is raised in order to facilitate work on the top plate. The customer service robot 1 is provided with an arm portion for elevating the top plate.

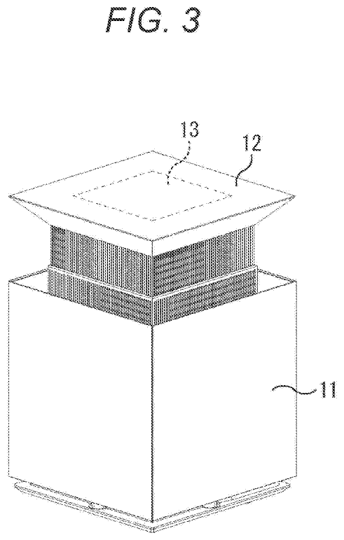

FIG. 3 is an enlarged view of the customer service robot 1 at the time of interaction.

As illustrated by a broken line, a top plate 12 has built therein a data processing terminal 13 such as a tablet terminal having a display equipped with a touch panel. At the time of interaction, characters and images serving as a questionnaire are displayed on the display provided in a range illustrated by the broken line. The user inputs data such as answers to the questionnaire by operating a button displayed on the display of the data processing terminal 13 with a finger or the like.

In this manner, the top plate 12 is used as a desk when the user performs work such as answering a questionnaire.

In a case where the questionnaire is completed, the customer service robot 1 closes the upper surface of a housing 11 with the top plate 12 by lowering the top plate 12, and returns to a home position in a simple box-like state illustrated in A of FIG. 2.

In this manner, the customer service system in FIG. 1 is a system in which the customer service robot 1, which is blended in the space like a simple box, approaches the user, and takes a questionnaire by changing the posture as if asking the user.

The user, who has seen the top plate 12 of the customer service robot 1 moving to a position near the user rising, can intuitively confirm that the questionnaire should be answered. Furthermore, the user can answer the questionnaire in such a manner as to communicate with the customer service robot 1.

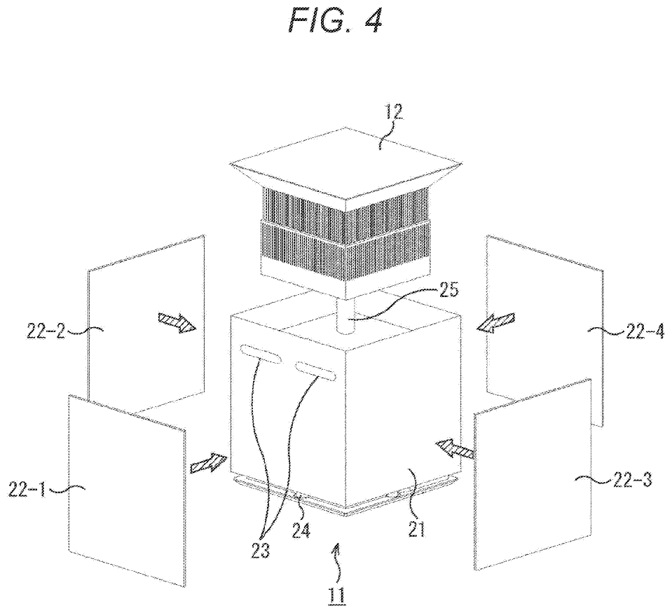

FIG. 4 is an exploded view of the housing 11.

As illustrated in FIG. 4, panels 22-1 to 22-4 are attached to side surfaces of a box-shaped main body 21. The panels 22-1 to 22-4 are, for example, resin panels serving as half mirrors.

A depth camera 23 is provided on the upper side of the front surface of the main body 21. Imaging by the depth camera 23 is performed through the panel 22-1 attached to the front surface. A LiDAR 24 is provided below the front surface of the main body 21.

A columnar support arm 25 is provided on the upper surface of the main body 21. By extending and contracting the support arm 25 or moving the support arm 25 in the up-down direction, elevation of the top plate 12 secured to the upper end of the support arm 25 is controlled. A driving unit such as a motor and a gear for extending and contracting the support arm 25 or moving the support arm 25 in the up-down direction is provided inside the main body 21.

Inside the main body 21, configurations such as a computer that performs various types of processing, a moving mechanism such as a tire, and a power supply are also provided.

Each of the customer service robots 1 illustrated in FIG. 1 has the above-described configuration.

<Configuration Example of Customer Service System>

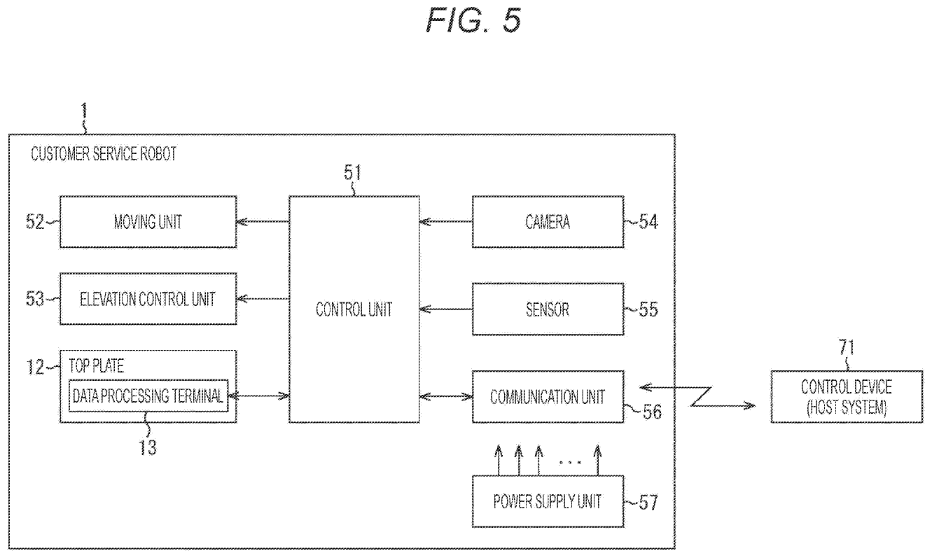

FIG. 5 is a block diagram illustrating a configuration example of the customer service system.

As illustrated in FIG. 5, the customer service system includes the customer service robot 1 and a control device 71. The customer service robot 1 and the control device 71 are connected via wireless communication.

The customer service robot 1 includes a control unit 51, a moving unit 52, an elevation control unit 53, a camera 54, a sensor 55, a communication unit 56, and a power supply unit 57. As described above, the data processing terminal 13 is built in the top plate 12 of the customer service robot 1.

The control unit 51 includes a computer. The control unit 51 executes a predetermined program by means of a CPU to control the overall operation of the customer service robot 1.

The moving unit 52 rotates the tire by driving the motor and the gear, and achieves movement of the customer service robot 1. The moving unit 52 functions as a moving unit that achieves movement of the customer service robot 1 while controlling the moving speed and the moving direction in accordance with control of the control unit 51.

The elevation control unit 53 controls extension and contraction of the support arm 25 by driving the motor and the gear.

The camera 54 includes the depth camera 23 in FIG. 4 that captures a range image, an RGB camera that captures an RGB image, an IR camera that captures an IR image, and the like. An image captured by the camera 54 is output to the control unit 51.

The sensor 55 includes various sensors such as an acceleration sensor, a gyro sensor, a motion sensor, an encoder that detects rotation speed of the tire provided in the moving unit 52, and the LiDAR 24. Information indicating a sensing result provided by the sensor 55 is output to the control unit 51.

At least one of the camera 54 or the sensor 55 may be provided outside the customer service robot 1. In this case, an image captured by the camera 54 provided outside the customer service robot 1 or information indicating a sensing result provided by the sensor 55 provided outside the customer service robot 1 is transmitted to the customer service robot 1 via wireless communication.

The communication unit 56 performs wireless communication with the control device 71. The communication unit 56 transmits information regarding approval application described later to the control device 71, and receives information transmitted from the control device 71 and outputs the information to the control unit 51.

The power supply unit 57 includes a battery. The power supply unit 57 supplies power to each unit of the customer service robot 1.

The control device 71 includes a data processing device such as a PC. The control device 71 functions as a host system that controls the action of each of the customer service robots 1.

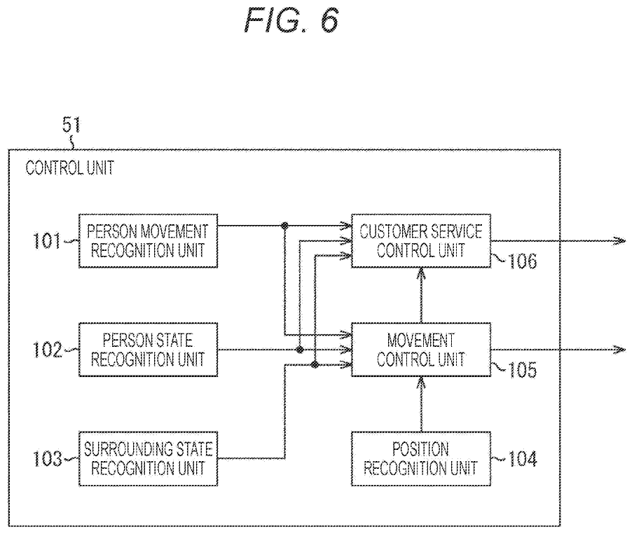

FIG. 6 is a block diagram illustrating a functional configuration example of the control unit 51.

At least a part of the functional units illustrated in FIG. 6 is fulfilled as a predetermined program is executed by the CPU of the computer constituting the control unit 51.

In the control unit 51, a person movement recognition unit 101, a person state recognition unit 102, a surrounding state recognition unit 103, a position recognition unit 104, a movement control unit 105, and a customer service control unit 106 are fulfilled.

The person movement recognition unit 101 recognizes a state of movement of the user on the basis of an image captured by the camera 54 and a sensing result provided by the sensor 55.

As the state of movement of the user, for example, a distance from the current position of the customer service robot 1 to the position of the user is recognized. Information indicating a recognition result provided by the person movement recognition unit 101 is supplied to the movement control unit 105 and the customer service control unit 106.

The person state recognition unit 102 recognizes a state of the user on the basis of the image captured by the camera 54 and the sensing result provided by the sensor 55.

As the state of the user, for example, who the user is and an attribute of the user (whether the user is a child or an adult, and the like) are identified. Information indicating a recognition result provided by the person state recognition unit 102 is supplied to the movement control unit 105 and the customer service control unit 106.

The surrounding state recognition unit 103 recognizes a state of a surrounding environment on the basis of the image captured by the camera 54 and the sensing result provided by the sensor 55.

As the state of a surrounding environment, a state of another customer service robot 1 around is recognized. The state of another customer service robot 1 that the surrounding state recognition unit 103 recognizes includes a distance to another customer service robot 1 and a height of the top plate 12 of another customer service robot 1.

Furthermore, as the state of a surrounding environment, a state of a surrounding user is recognized. The state of a user that the surrounding state recognition unit 103 recognizes includes, in a case where the user carries a baggage, a state of the baggage.

Information indicating a recognition result provided by the surrounding state recognition unit 103 is supplied to the movement control unit 105 and the customer service control unit 106.

The position recognition unit 104 recognizes a self-position in the space where the customer service system is installed, and outputs information indicating a recognition result to the movement control unit 105. As will be described later, the recognition of the self-position by the position recognition unit 104 is performed in a different method depending on the area where the customer service robot 1 is located.

The movement control unit 105 drives the moving unit 52 on the basis of the respective recognition results of the person movement recognition unit 101, the person state recognition unit 102, and the surrounding state recognition unit 103 and the self-position recognized by the position recognition unit 104, and controls movement of the customer service robot 1.

For example, in a case where the movement control unit 105 specifies that there is a user as a target of customer service on the basis of the recognition result provided by the person movement recognition unit 101, the movement control unit 105 moves the customer service robot 1 to a position near the user.

The customer service control unit 106 drives the elevation control unit 53 on the basis of the respective recognition results of the person movement recognition unit 101, the person state recognition unit 102, and the surrounding state recognition unit 103, and controls elevation of the top plate 12. Furthermore, after raising the top plate 12, the customer service control unit 106 controls the data processing terminal 13 to provide a customer service by displaying a screen used for a questionnaire.

For example, the customer service control unit 106 recognizes a position of the user as a target of customer service on the basis of the recognition result provided by the person movement recognition unit 101. The customer service control unit 106 extends the support arm 25 and increases the height of the top plate 12 in response to the movement to a position near the user as a target of customer service.

Furthermore, the customer service control unit 106 adjusts the height of the top plate 12 to an optimum height for the user to perform work on the basis of the recognition result provided by the person state recognition unit 102 and the like.

The customer service control unit 106 identifies whether the target of customer service is a child or an adult on the basis of the recognition result provided by the person state recognition unit 102. In a case where the target user is a child, the customer service control unit 106 adjusts the height of the top plate 12 to a height lower than that in a case where the target user is an adult.

The customer service control unit 106 specifies the height of the top plate 12 of another nearby customer service robot 1 on the basis of the recognition result provided by the surrounding state recognition unit 103. The customer service control unit 106 adjusts the height of the top plate 12 of the own to a similar height to that of the top plate 12 of another customer service robot 1.

Furthermore, the customer service control unit 106 specifies the height of the baggage that the target user carries on the basis of the recognition result provided by the surrounding state recognition unit 103. The customer service control unit 106 adjusts the height of the top plate 12 of the own to a similar height to that of the baggage that the target user carries. The user can put his/her baggage on the top plate 12 adjusted in height with a natural movement.

In this manner, the movement control unit 105 and the customer service control unit 106 function as control units that control movement of the customer service robot 1 and that control elevation of the top plate 12.

<Function of Customer Service Robot 1>

As described above, the customer service robot 1 is a robot that provides a customer service to a user as a customer in an open space where a plurality of users (persons) is present. The customer service robot 1 has the following functions.

(1) Combination of dead reckoning and star reckoning

(2) Cooperation of plurality of robots

(3) Motion of robot in assigned area

Each of the functions will be described.

(1) Combination of dead reckoning and star reckoning

As a self-localization method, the customer service robot 1 uses dead reckoning in a crowded environment, and uses star reckoning before an error exceeds an allowable range to correct a self-position.

The space where the customer service robot 1 is disposed is divided into two areas of a backyard area, which is an area serving as a backyard, and a service area, which is an area where a customer service is actually provided. The customer service robot 1 moves back and forth between the two areas.

Since the backyard area is prepared, the customer service robot 1 can correct the self-position by performing the star reckoning without giving a sense of discomfort to the user at a place that is not visible to the user.

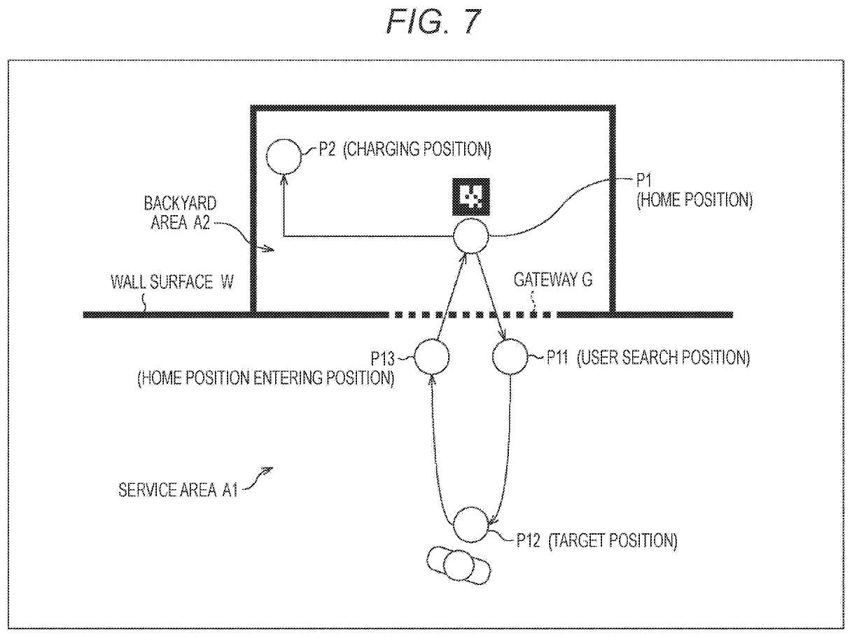

FIG. 7 is a diagram schematically illustrating a space where the customer service robot 1 is disposed.

As illustrated in FIG. 7, a service area A1 and a backyard area A2 are set in the space where the customer service robot 1 is disposed. The service area A1 and the backyard area A2 are divided by a wall surface W. As illustrated by a broken line, an opening is formed at a part of the wall surface W, and the opening is used as a gateway G of the backyard area A2.

The service area A1 is an area where the self-localization is performed by means of dead reckoning. On the other hand, the backyard area A2 is an area where the self-localization is performed by means of star reckoning.

The dead reckoning is a self-localization method by using an output of a sensor inside the robot, such as an axle encoder and an inertial measurement unit (IMU). Although the dead reckoning is suitable for use in the service area A1 since the self-localization can be performed in a situation where the surroundings are congested, an error increases in accordance with the travel distance and the elapsed time.

On the other hand, the star reckoning is a self-localization method based on an outside situation such as marker recognition using the camera 54 and recognition using LiDAR SLAM.

In the backyard area A2, a marker is provided at a position P1 serving as a home position. As the customer service robot 1 recognizes the marker and moves to the position P1, correction of the self-position, that is, initialization of the error increased by use of the robot in the service area A1, is performed.

A charging position is set at a position P2 in the backyard area A2. For example, in a case where the battery charge remaining amount of the customer service robot 1 falls below a preset threshold amount, the state of the customer service robot 1 enters a standby state, and the battery is charged at the position P2.

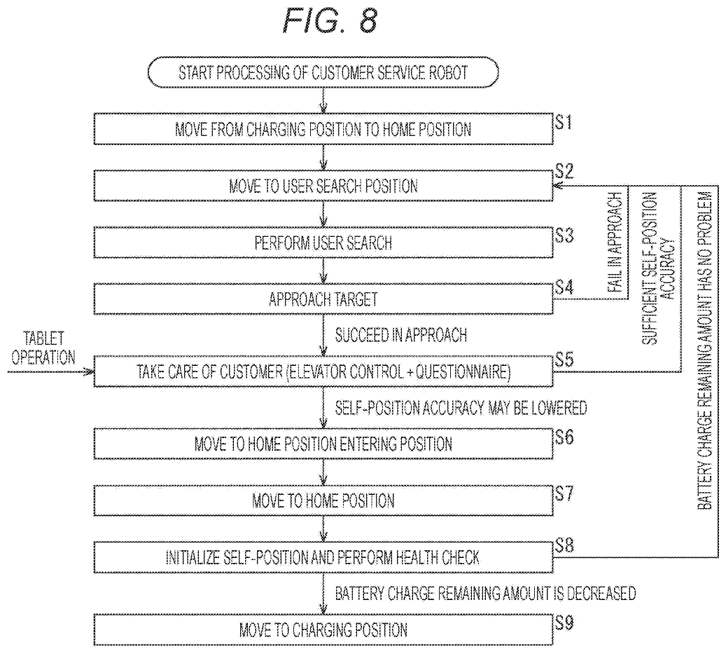

Processing of the customer service robot 1 will be described with reference to the flowchart in FIG. 8. FIG. 7 will be referred to as appropriate.

The processing in FIG. 8 is started, for example, when charging of the battery of the customer service robot 1 is completed.

In step S1, the movement control unit 105 of the customer service robot 1 moves from the charging position (position P2) to the home position (position P1).

After moving to the home position, in step S2, the movement control unit 105 moves to a user search position set in its own assigned area in the service area A1. In the example in FIG. 7, a position P11 as a user search position is set.

After the movement to the user search position, in step S3, the person movement recognition unit 101 performs user search.

In a case where a target user is recognized by the user search, in step S4, the movement control unit 105 approaches the user. In the example in FIG. 7, a position P12 as a position in front of the target user is set as a target position.

After the movement to the target position, in step S5, the customer service control unit 106 takes care of the customer.

That is, the customer service control unit 106 raises the top plate 12 by controlling the elevation control unit 53, and causes a questionnaire to be answered using the data processing terminal 13. When the questionnaire is completed, the customer service control unit 106 changes its own posture from the posture at the time of interaction to the posture at the time of traveling.

In step S6, the movement control unit 105 moves to a home position entering position. In the example in FIG. 7, a position P13 as a home position entering position is set in the vicinity of the gateway G.

For example, after the movement to the home position entering position, communication is performed with the control device 71 serving as the host system, and an application for approval of entering the backyard area A2 is made to the host system. The application for approval to the host system will be described later.

In a case where the entry into the backyard area A2 is permitted, in step S7, the movement control unit 105 moves to the home position in the backyard area A2.

After the movement to the home position, in step S8, the position recognition unit 104 initializes the self-position and performs a health check. The health check includes, for example, a check of the battery charge remaining amount.

In a case where the battery charge remaining amount falls below the threshold amount, in step S9, the movement control unit 105 moves to the charging position and performs charging. After the charging is completed, the processing from step S1 is repeated.

Note that, in a case where the movement is started with the target position as the destination in step S4, but the approach to the target user fails, the processing returns to step S2, and the user search is performed again after the movement to the user search position.

Similarly, in a case where the accuracy of the self-position can be sufficiently secured after the customer caring is performed in step S5, the processing returns to step S2, and the user search is performed again after the movement to the user search position.

For example, in a case where the travel distance after the most recent initialization of the self-position does not exceed a threshold distance, or in a case where the elapsed time after the most recent initialization of the self-position does not exceed threshold time, it is determined that the accuracy of the self-position is sufficiently secured.

Similarly, in a case where the battery charge remaining amount is equal to or larger than the threshold amount as a result of the health check in step S8, the processing returns to step S2, and the user search is performed again after the movement to the user search position.

(2) Cooperation of Plurality of Robots

The service area A1 is divided into a plurality of areas, and an area (assigned area) in charge of customer service is assigned to each of the customer service robots 1.

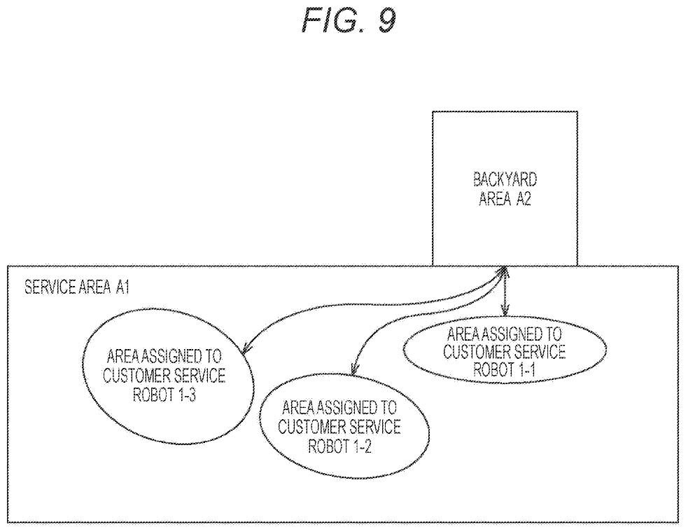

FIG. 9 is a diagram illustrating examples of assigned areas.

In the example in FIG. 9, respective assigned areas of an area assigned to the customer service robot 1-1, an area assigned to the customer service robot 1-2, and an area assigned to the customer service robot 1-3 are set.

Each of the customer service robots 1 moves from the home position in the backyard area A2 to the user search position set in each of the assigned areas, and then performs the user search or the like as described above.

When returning to the backyard area A2, each of the customer service robots 1 moves to the home position entering position, applies to the host system for entry into the backyard area A2, and enters the backyard area A2 after permission is obtained. For example, at a certain time, only one customer service robot 1 is permitted to pass through the gateway G.

Accordingly, it is possible to prevent the plurality of customer service robots 1 from competing or interfering with each other at the gateway G.

(3) Motion of Robot in Assigned Area

The customer service robot 1 recognizes the user on the basis of an image captured by the depth camera 23 (RGB-D sensor) and then approaches the user to provide a customer service. Since the range in which the user can be recognized is limited, the customer service robot 1 needs to search for the user while moving in the assigned area. A plurality of user search positions is set in the assigned area.

For example, the assigned area is divided in a truss structure. The customer service robot 1 searches for the user while moving to a vertex of each truss.

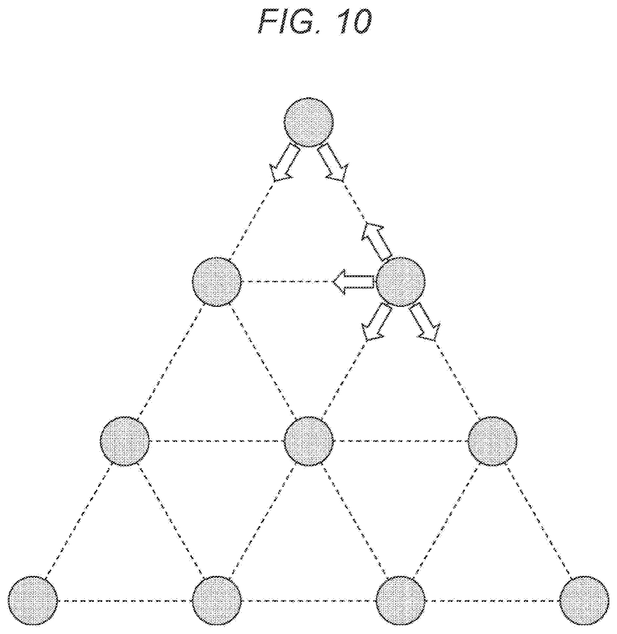

FIG. 10 is a diagram illustrating an example of division of the assigned area.

In the example in FIG. 10, nine trusses are formed in the assigned area. A vertex of each truss illustrated by a circle corresponds to the user search position. As illustrated by an outlined arrow, at the user search position, the user search is performed in a state of facing an adjacent node (in a state of causing the front surface of the housing 11 provided with the depth camera 23 to face the adjacent node).

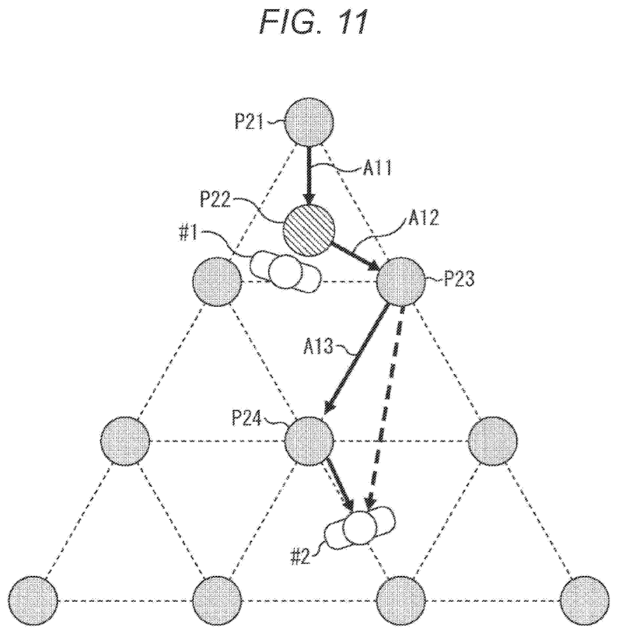

FIG. 11 is a diagram illustrating an example of the user search.

For example, in a case where a user #1 is recognized by the user search performed at a position P21, the customer service robot 1 moves to a position P22 with the user #1 as a target as illustrated by an arrow A11. The position P22 corresponds to the target position. After moving to the position P22, the customer service robot 1 performs customer caring.

In a case where the customer caring has been completed, and the accuracy of the self-position is sufficiently secured, the customer service robot 1 moves to a position P23, which is the nearest adjacent node from the position P22, which is the current position, as illustrated by an arrow A12, and performs the user search again.

For example, in a case where the direction of a user #2 can be recognized by the user search performed at the position P23, but the specific position cannot be recognized, the customer service robot 1 moves to a position P24, which is an adjacent node located in the direction of the user #2, as illustrated by an arrow A13. After moving to the position P24, the customer service robot 1 searches for the user. In a case where the position of the user #2 can also be recognized, the customer service robot 1 moves to the vicinity of the user #2 and performs customer caring.

With such processing, it is possible to cause the customer service robot 1 to flexibly approach the user in the assigned area while limiting the moving region.

### MODIFICATION EXAMPLES

Although it is assumed that the work required for the user is an answer to the questionnaire, various kinds of work such as ordering a ticket, ordering a good, ordering a dish, and confirming an exhibit content may be performed using the customer service robot 1.

Although it is assumed that the state of the customer service robot 1 at the time of movement is a state in which the housing 11 and the top plate 12 overlap, and in which the top plate 12 closes the upper surface of the housing 11, the top plate 12 may be housed inside the housing 11.

The series of pieces of processing described above can be executed by hardware or software. In a case where the series of pieces of processing is executed by software, a program constituting the software is installed from a program recording medium to a computer incorporated in dedicated hardware, a general-purpose personal computer, or the like.

The program executed by the computer may be a program in which processing is performed in chronological order in the order described in the present description, or may be performed in parallel or at a necessary time such as at a time when calling is performed.

In the present description, the system means a set of a plurality of components (devices, modules (parts), and the like), and it does not matter whether or not all the components are in the same housing. Therefore, both a set of a plurality of devices housed in separate housings and connected via a network and a device having a plurality of modules housed in one housing are systems.

Note that effects described in the present description are illustrative only and shall not be limited, and other effects may exist.

The embodiment of the present technology is not limited to the aforementioned embodiment, and various changes can be made without departing from the scope of the present technology.

For example, the present technology can be configured as cloud computing in which one function is shared and jointly processed by a plurality of devices via a network.

### REFERENCE SIGNS LIST

1 Customer service robot
51 Control unit
52 Moving unit
53 Elevation control unit
54 Camera
55 Sensor
56 Communication unit
57 Power supply unit
71 Control device

1. A moving body comprising:
a top plate that serves as a desk at which a person performs work;
a support arm that supports the top plate and that can extend and contract;
a moving unit that holds the support arm and performs movement for causing the work to be performed; and
a control unit that controls a posture state including a state of the support arm and a movement state of the moving unit in accordance with a relationship with an environment state as a state of a surrounding environment and a person state as a state of the person located around, sensed by a sensor.

2. The moving body according to claim 1, further comprising:
a person movement recognition unit that recognizes a movement state of the person,
wherein the control unit controls the posture state and the movement state in accordance with the movement state of the person recognized by the person movement recognition unit.

3. The moving body according to claim 2,
wherein the movement state of the person is a distance between the moving body and the person, and
the control unit extends the support arm to increase a height of the top plate as the distance decreases.

4. The moving body according to claim 3,
wherein the control unit adjusts extension and contraction of the support arm in order for the height of the top plate to be a height corresponding to the work performed by the person.

5. The moving body according to claim 1, further comprising:
a person state recognition unit that recognizes the person state,
wherein the control unit controls the posture state and the movement state in accordance with the person state recognized by the person state recognition unit.

6. The moving body according to claim 5,
wherein the person state recognition unit identifies the person who performs the work, and
the control unit controls the posture state and the movement state in accordance with the person identified by the person state recognition unit.

7. The moving body according to claim 1, further comprising:
a surrounding state recognition unit that recognizes the environment state,
wherein the control unit further controls the posture state and the movement state in accordance with the environment state recognized by the surrounding state recognition unit.

8. The moving body according to claim 7,
wherein the surrounding state recognition unit recognizes a state of another moving body, and
the control unit controls the posture state and the movement state in accordance with the state of the another moving body recognized by the surrounding state recognition unit.

9. The moving body according to claim 8,
wherein the surrounding state recognition unit recognizes a height of a top plate of the another moving body, and
the control unit controls the posture state in order for the height of the top plate to be a similar height to the height of the top plate of the another moving body.

10. The moving body according to claim 9,
wherein the surrounding state recognition unit recognizes a state of a baggage that the person carries, and
the control unit controls the posture state in accordance with the state of the baggage recognized by the surrounding state recognition unit.

11. The moving body according to claim 10,
wherein the state of the baggage is a height at which the baggage is located, and
the control unit controls the posture state in order for the height of the top plate to be a similar height to the height at which the baggage is located.

12. The moving body according to claim 1,
wherein, in a case where the work is not performed by the person, the control unit controls the posture state in order for the top plate and the moving unit to be in an overlapping state or in order for the top plate to be housed in the moving unit.

13. The moving body according to claim 1,
wherein the top plate has built therein a data processing terminal used for the work performed by the person.

14. The moving body according to claim 13,
wherein the work is data input performed by the person.

15. The moving body according to claim 1,
wherein the moving unit includes a power supply that operates a driving portion for movement, and
the control unit changes a position of the moving body in accordance with a battery charge remaining amount of the power supply.

16. The moving body according to claim 15,
wherein the control unit controls the posture state and the movement state so as to be in a standby state in a case where the battery charge remaining amount of the power supply falls below a preset threshold value.

17. A control method comprising:
controlling a posture state including a state of a support arm and a movement state of a moving unit in accordance with a relationship with an environment state as a state of a surrounding environment and a person state as a state of a person located around, sensed by a sensor, in a moving body including
a top plate that serves as a desk at which the person performs work,
the support arm that supports the top plate and that can extend and contract, and
a moving unit that holds the support arm and performs movement for causing the work to be performed.
